(19) United States
(12) Patent Application Publication
(10) Pub. No.: US 2013/0174144 A1
(43) Pub. Date: Jul. 4, 2013

(54) HARDWARE BASED VIRTUALIZATION SYSTEM

(71) Applicants: Gongxian J. Cheng, Toronto (CA); Anthony Asaro, Toronto (CA)

(72) Inventors: Gongxian J. Cheng, Toronto (CA); Anthony Asaro, Toronto (CA)

(73) Assignee: ATI TECHNOLOGIES ULC, Markham (CA)

(21) Appl. No.: 13/338,915

(22) Filed: Dec. 28, 2011

(51) Int. Cl. G06F 9/455

(52) U.S. Cl. 718/1

(57) ABSTRACT

A method for changing between virtual machines on a graphics processing unit (GPU) includes requesting to switch from a first virtual machine (VM) with a first global context to a second VM with a second global context; stopping taking of new commands in the first VM; saving the first global context; and switching out of the first VM.

### FIELD OF THE INVENTION

This application relates to hardware-based virtual devices and processors.

### BACKGROUND

FIG. 1 is a block diagram of an example device 100 in which one or more disclosed embodiments may be implemented in the graphics processing unit (GPU). The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a GPU, a CPU and GPU located on the same die, which may be referred to as an Accelerated Processing Unit (APU), or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner is the input driver 112 and the output driver 114 are not present.

With reference to FIG. 1A, which shows GPU context switching and hierarchy in a native (non-virtual) environment, a system boot 120 causes the basic input output system (video BIOS) 125 to establish a preliminary global context 127. Following, or even contemporaneously with the video BIOS startup, the operating system (OS) boots 130, loads its base drivers 140, and establishes a global context 150.

Once the system and OS have booted, on application launch 160, GPU user mode drivers start 170, and those drivers drive one or more per-process contexts 180. In a case where more than one per-process context 180 is active, the multiple contexts may be switched between.

FIG. 1A represents a GPU context management scheme in a native/non-virtualized environment. In this environment, each of the per-process contexts 180 shares the same, static, global context and preliminary global context—and each of these three contexts is progressively built on its lower level context (per-process on global on preliminary). Global context examples may include GPU: ring buffer settings, memory aperture settings, page table mappings, firmware, and microcode versions and settings. Global contexts may be different depending on individual and particularities of the OS and driver implementations.

A virtual machine (VM) is an isolated guest operating system installation within a host in a virtualized environment. A virtualized environment runs one or more of the VMs are run in a same system simultaneously or in a time-sliced fashion. In a virtualized environment, there are certain challenges, such as switching between multiple VMs, which may result in switching among different VMs using different settings in their global contexts. Such a global context switching mechanism is not supported by the existing GPU context switching implementation. Another challenge may result when VMs launch asynchronously and a base driver for each VM attempts to initialize its own global context without knowledge of other running VMs—which results in the base driver initialization destroying the other VM's global context (for example, a new code upload overrides existing running microcode from another VM). Still other challenges may arise in hardware-based virtual devices where a central processing unit (CPU or graphics processing unit (GPU)) physical properties may need to be shared among all of the VMs. Sharing GPU's physical features and functionality such as display links and timings, DRAM interface, clock settings, thermal protection, PCIE interface, hang detection and hardware resets may cause another challenge, as those types of physical functions are not designed to be shareable among multiple VMs.

The software-only implementations of virtual devices such as the GPU provide for limited performance, feature sets, and security. Furthermore, the large number of different virtualization systems implementations and OSes operating systems all require specific software development, which is not economically scalable.

### SUMMARY

A method for changing between virtual machines on a graphics processing unit (GPU) includes requesting to switch from a first virtual machine (VM) with a first global context to a second VM with a second global context; stopping taking of new commands in the first VM; saving the first global context; and switching out of the first VM.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more disclosed embodiments may be implemented.

FIG. 1A shows context switching and hierarchy in a native environment.

FIG. 2 shows a hardware-based VM system similar to FIG. 1.

FIG. 3 shows the steps for switching out of a VM.

FIG. 4 shows the steps for switching into of a VM.

FIG. 5 graphically shows the resource cost of a synchronous global context switch.

### DETAILED DESCRIPTION

Hardware-based virtualization allows for guest VMs to behave as if they are in a native environment, since the guest OS and VM drivers may have no or minimal awareness of their VM status. Hardware virtualization may also require minimal modification to the OS and drivers. Thus, hardware virtualization allows for maintenance of an existing software ecosystem.

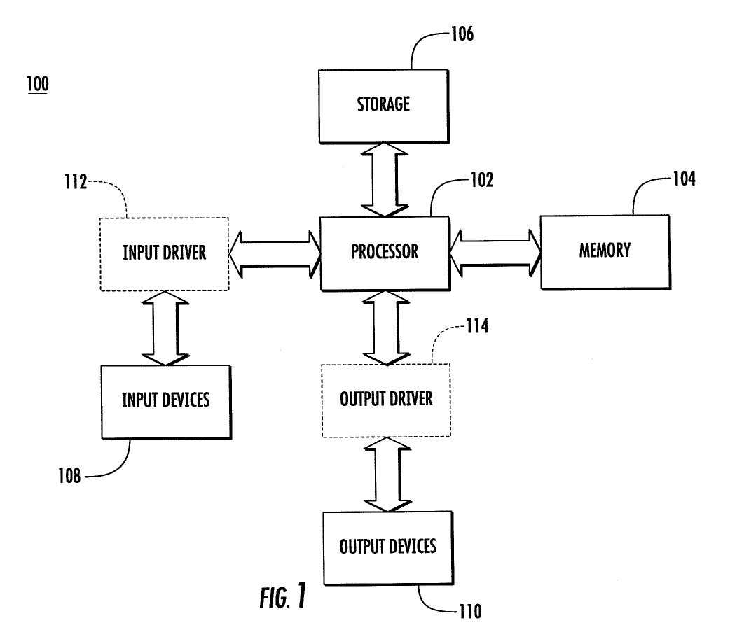

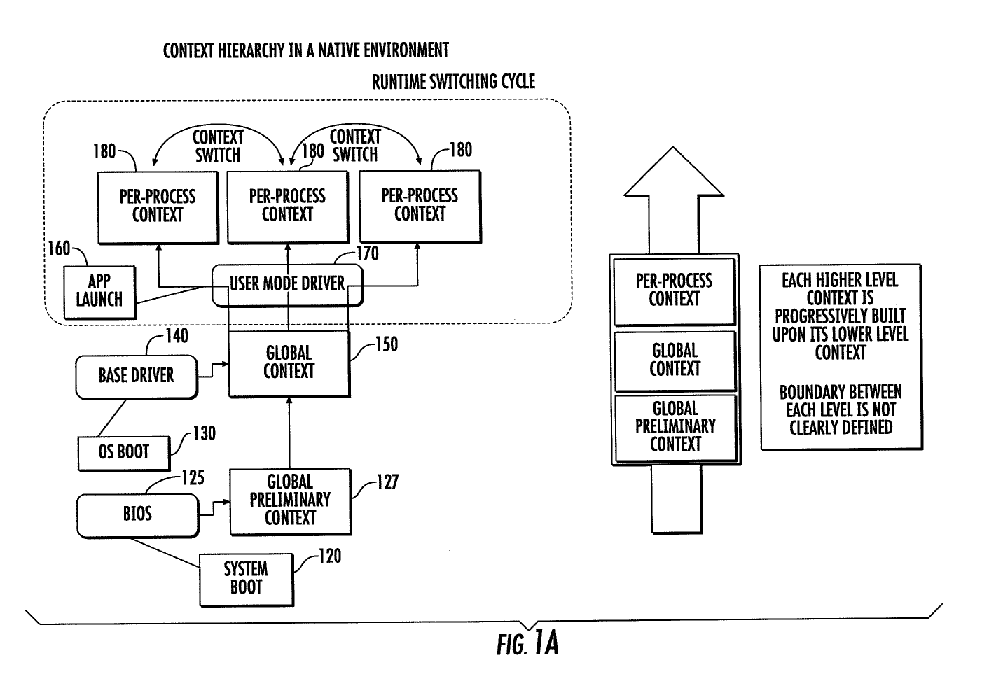

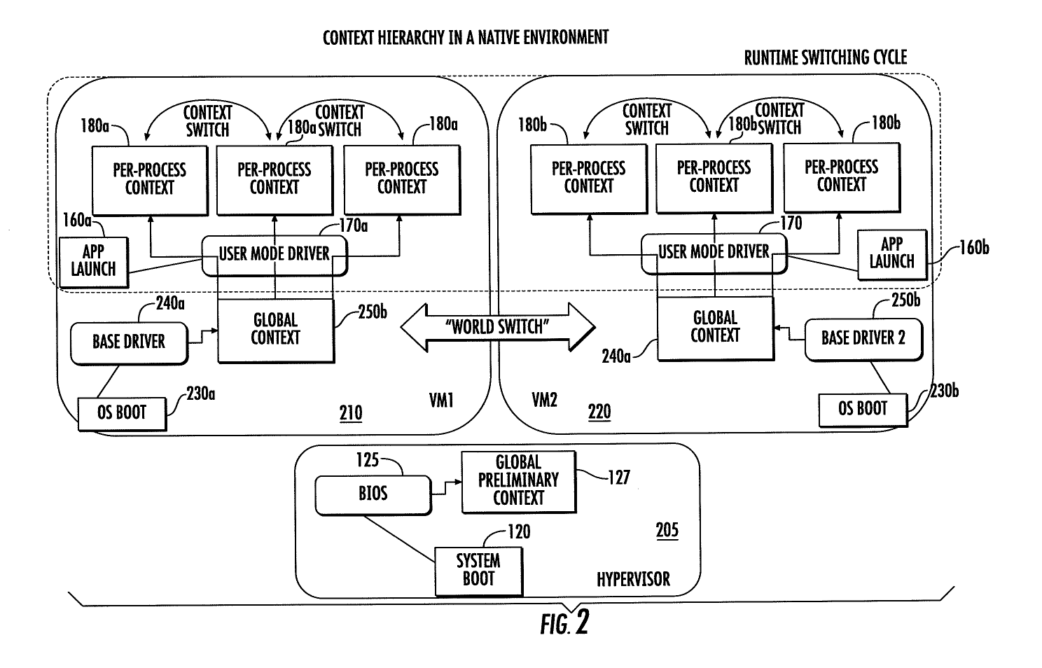

FIG. 2 shows a hardware-based VM system similar to FIG. 1A, but with two VMs 210, 220. The system boot 120 and the BIOS 125 establishing the preliminary context 127 are done by the CPU's hypervisor, which is a software-based entity that manages the VMs 210, 220 in a virtualized system. The hypervisor may control the host processor and resources, allocating needed resources to each VM 210,220 in turn and ensures that each VM does not disrupt the other.

Each VM 210, 220 has its own OS boot 230a, 230b, and respective base drivers 240a, 240b establish respective global contexts 250a, 250b. The app launch 160a, 160b, user mode driver 170a, 170b, and contexts 180a, 180b are the same as FIG. 1 within each of the VMs.

Switching from VM1 210 to VM2 220 is called a world switch, but in each VM, certain global preliminary context established in step 120 is shared, while other global context established at 250a, 250b is different. It can be appreciated that in this system, each VM 210, 220 has its own global context 250a, 250b—and each global context is shared on a per-application basis. During a world switch from VM1 210 to VM2 220, global context 250b may be restored from GPU memory, while global context 250a is saved in the same (or different) hardware-based GPU memory.

Within the GPU, each GPU IP block may define its own global context, with settings made by the base driver of its respective VM at VM initialization time. These settings may be shared by all applications within a VM. Physical resources and properties such as the DRAM interfaces that are shared by multiple VMs are initialized outside of the VMs and are not part of the global contexts that are saved and restored during global context switch. Examples of GPU IP blocks include the graphics engine, GPU compute units, DMA Engine, video encoder, and video decoder.

Within this hardware-based VM embodiment, there may be physical functions (PFs) and virtual functions (VFs) defined as follows. Physical functions (PFs) may be full-featured express functions that include configuration resources (e.g., PCI-Express functions); virtual functions (VFs) are “lightweight” functions that lack configuration resources. Within the hardware-based VM system, a GPU may expose 1 PF per PCI express standard. In a native environment, the PF may be used by a driver as it normally would be; in the virtual environment, the PF may be used by the hypervisor or Host VM. Furthermore, all GPU registers may be mapped to the PF.

The GPU may offer N VFs. In the native environment, VFs are disabled; in the virtual environment, there may be one VF per VM, and the VF may be assigned to the VM by the hypervisor. A subset of GPU registers may be mapped to each VF sharing a single set of physical storage flops.

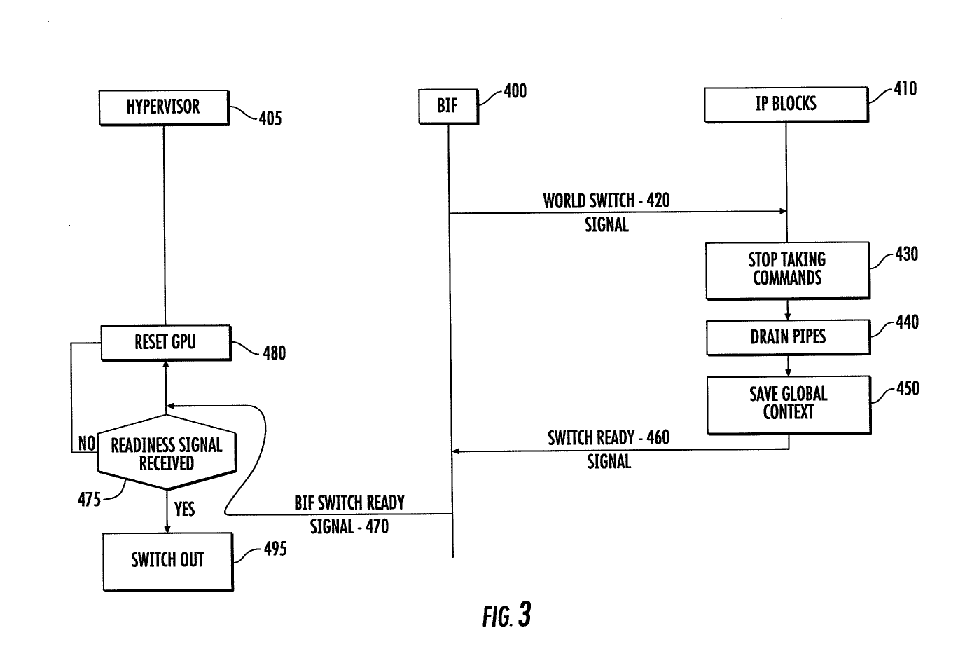

A global context switch may involve a number of steps, depending on whether the switch is into, or out of a VM. FIG. 3 shows the steps for switching out of a VM in the exemplary embodiment. Given the 1 VM to 1 VF or PF mapping, the act of switching from one VM to another VM equates to the hardware implementation of switching from one VF or PF to another VF or PF. During the global context switch, the hypervisor uses PF configuration space registers to switch the GPU from one VF to another, and the switching signal is propagated from one bus interface (BIF) or delegate to all IP blocks. Prior to the switch, the hypervisor must disconnect the VM from the VF (by unmapping MMIO register space, if previously mapped) and ensure any pending activity in the system fabric has been flushed to the GPU.

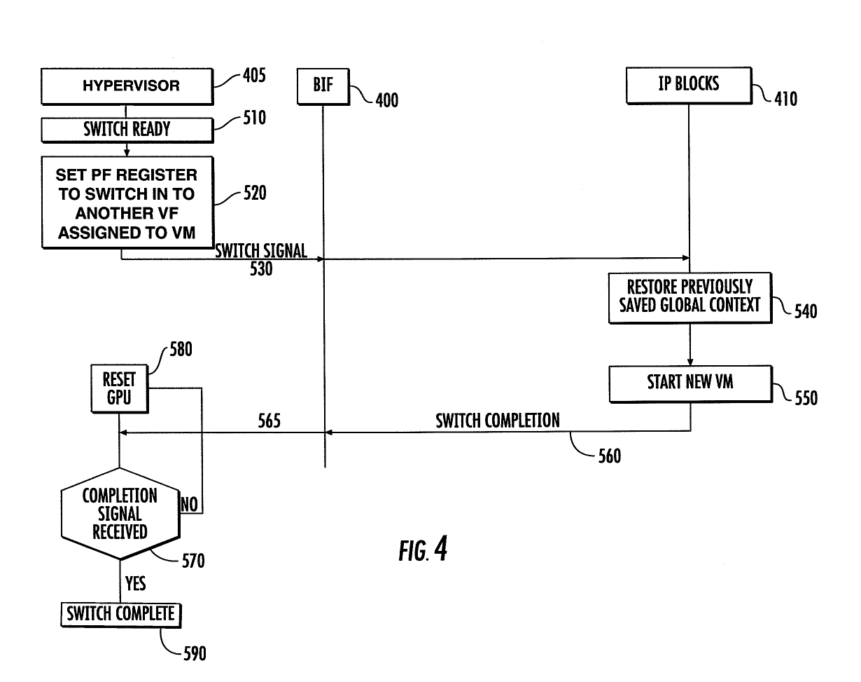

Upon receipt of this global context switch-out signal 420 from the BIF 400, every involved IP block 410 may do the following, not necessarily in this order—or any order, as some tasks may be done contemporaneously. First, the IP block 410 may stop taking commands from the software 430 (such “taking” could be refraining to transmit further commands to the block 410 or, alternatively, stop retrieving or receiving commands by block 410). Then it drains its internal pipeline 440, which includes allowing commands in the pipeline to finish processing and resulting data to be flushed to memory, but accepts no new commands (see step 420), until reaching its idle state. This is done so that the GPU carries no existing commands to the new VF/PF—and can accept the new global context when switching into the next VF/PF (see FIG. 4). IPs with inter-dependencies may need to co-ordinate state save (e.g. 3D engine and the memory controller).

Once idle, the global context may be saved to memory 450. The memory location may be communicated from the hypervisor via a PF register from the BIF. Finally, each IP block responds to the BIF with an indication for switch-out completion 460.

Once the BIF collects all the switch-out completion responses, it signals the hypervisor 405 for global context switching readiness 470. If the hypervisor 405 does not receive the readiness signal 470 in a certain time period 475, the hypervisor resets the GPU 480 via a PF register. Otherwise, on receipt of the signal, the hypervisor ends the switch out sequence at 495.

FIG. 4 describes the steps for switching into a VF/PF. Initially, the PF register indicates a global context switching readiness 510. The hypervisor 405 then sets a PF register in BIF to switch into another VF/PF assigned to a VM 520, and a switching signal may be propagated from the BIF to all IP blocks 530.

Once the IP blocks 410 receive the switch signal 530, each IP block may restore the previously saved context from memory 540 and start running the new VM 550. The IP blocks 410 then respond to the BIF 400 with a switch-completion signal 560. The BIF 400 signals the hypervisor 405 that the global context switch in is complete 565.

The hypervisor 405 meanwhile checks to see that the switch completion signal has been received 570, and if it has not, resets the GPU 580, otherwise, the switch-in sequence is complete 590.

Certain performance consequences may result from this arrangement. During global context switch out, there may be a wait time for all IP blocks to drain and idle. During global context switch in, although it is possible to begin running a subset of IP blocks before all IP blocks are runnable, this may be difficult to implement due to their mutual dependencies.

Understanding drain and stop timing gives an idea of performance, usability, overhead use, and responsiveness. The following formulas show examples for a human computer interaction (HCI) and GPU efficiency factors:

(1) HCI responsiveness factor:

(N−1)×(T+V)<=100 ms Equation 1

(2) GPU efficiency factor:

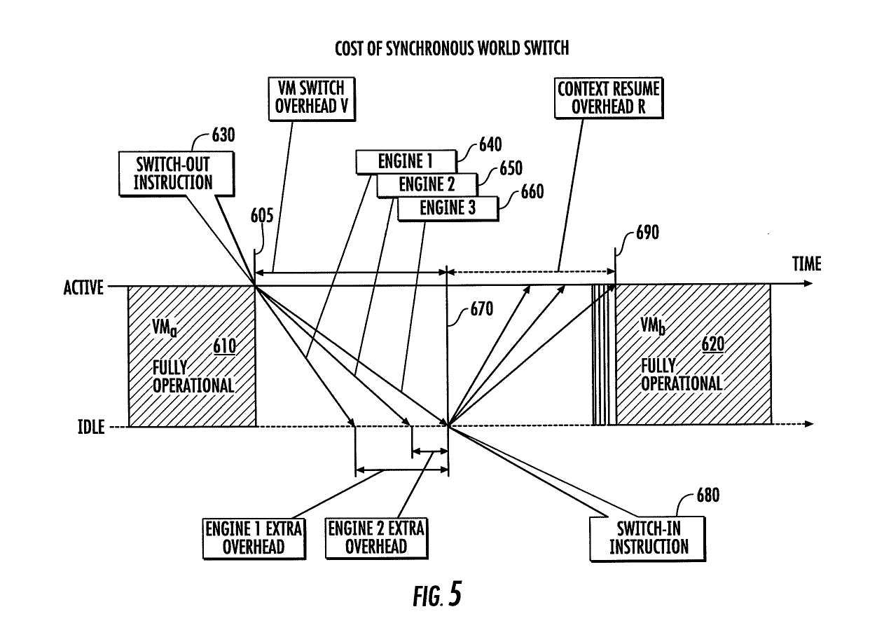

(T−R)/(T+V)=(80%→90%) Equation 2

Where N is the number of VMs, T is the VM active time, V is switch overhead, and R is context resume overhead. Several of these variables are best explained with reference to FIG. 5.

FIG. 5 graphically shows the resource cost of a synchronous global context switch. Switching between VMa 610, in an active state and VMb 620b, which starts in an idle state begins with a switch out instruction 630. At that point, the IP blocks 640, 650, 660 (called engines in the figure) begin their shut down, with each taking different times to reach idle. As discussed earlier, once each reaches idle 670, the switch in instruction 680 begins engines in the VMb 620's space, and the VMb 620 is operational once the engines are all active 690. The time between the switch out instruction marked as 605 and the switch in instruction 670 is VM switch overhead “V,” while the time from the switch in instruction 680 to the VMb 620 being fully operational at 690 is the context resume overhead R.

One embodiment of the hardware-based (for example GPU-based) system would make IP blocks capable of asynchronous execution, where multiple IP blocks may run asynchronously across several VFs or PF. In this embodiment, global contexts may be instantiated internally, with N contexts for N running VFs or the PF. Such an embodiment may allow autonomous global context switch without the hypervisor's active and regular switching instructions, with second level scheduling (global context) and a run list controller (RLC) may be responsible for context switching in the GPU, taking policy control orders from hypervisor, such as priority and preemption. The RLC may control IP blocks/engines and starts or stops individual engines. In this embodiment, global context for each VM may be stored and restored on-chip or in memory. Another feature in such an embodiment is that certain service IP blocks may maintain multiple, simultaneous global contexts. For example, a memory controller may simultaneously serve multiple clients running different VFs or PF asynchronously. It should be appreciated that such an embodiment may eliminate synchronous global context-switching overhead for the late-stopping IP blocks. Clients of the memory controller would indicate the VF/PF index in an internal interface to the memory controller, allowing the memory controller to apply the appropriate global context when serving the said client.

Asynchronous memory access may create scheduling difficulties that may be managed by the hypervisor. The hypervisor's scheduling function, in the context of the CPU's asynchronous access to GPU memory may be limited by the following factors: (1) The GPU memory is hard-partitioned, such that each VM is allotted 1N space; (2) the GPU host data path is a physical property always available for all VMs; and swizzle apertures are hard-partitioned among VFs. Instead of (1), however, another embodiment would create a memory soft-partition with a second level memory translation table managed by the hypervisor. The first level page table may already be used by a VM. The hypervisor may be able to handle page faults at this second level and also map physical pages on demand. This may minimize memory limitations, with some extra translation overhead.

The CPU may be running a VM asynchronously while the GPU is running another VM. This asynchronous model between the CPU and the GPU allows better performance there is no need for the CPU and the GPU to wait for each other in order to switch into the same VM at the same time. This model, however, exposes an issue where the CPU may be asynchronously accessing a GPU register, which is not virtualized, meaning that there may not be multiple instances of GPU registers per VF/PF, which may result in an area saving (less space taken up on the chip) on the GPU. This asynchronous memory access may create scheduling difficulties that may be managed by the hypervisor. Another embodiment that may improve performance may involve moving MMIO registers into memory.

In such an embodiment, the GPU may transfer frequent MMIO register access into memory access by moving ring buffer pointer registers to memory locations (or doorbells if they are instantiated per VF/PF). Further, this embodiment may eliminate interrupt-related register accesses by converting level-based interrupts into pulse-based interrupts and moving IH ring pointers to memory locations. This may reduce the CPU's MMIO register access and reduce the CPU page faults.

In another embodiment, the CPU may be running a VM asynchronously while the GPU is running another VM. This asynchronous model between the CPU and the GPU allows better performance there is no need for the CPU and the GPU to wait for each other in order to switch into the same VM at the same time. This model, however, exposes an issue where the CPU may be asynchronously accessing a GPU register, which is not virtualized, meaning that there may not be multiple instances of GPU registers per VF/PF, which may result in an area saving (less space taken up on the chip) on the GPU.

The hypervisor's scheduling function, in the context of the CPU's asynchronous access to GPU registers may be managed by the following factors: (1) GPU registers are not instantiated due to higher resource cost (space taken up on the chip); (2) CPU's memory mapped register access is trapped by the hypervisor marking the CPU's virtual memory pages invalid; (3) VMs that are not currently running on the GPU register access may cause a CPU page fault (insures that the CPU does not access a VM not-running on the GPU); (4) the hypervisor suspends the fault-causing driver thread on the CPU core until the fault-causing VM is scheduled to run on the GPU; (6) the hypervisor may switch the GPU into a fault-causing VM to reduce the CPU's wait on a fault (7) the hypervisor may initially mark all virtual register BARs in VFs invalid and only map the MMIO memory when a CPU's register access is granted, this reducing the overhead of regularly map and unmap the CPU virtual memory pages.

The GPU registers may be split between physical and virtual functions (PFs and VFs), and register requests from the may be forwarded to the System Register Bus Manager (SRBM, another IP block in the chip). The SRBM receives a request from the CPU with an indication as to whether the request is targeting a PF or VF register. The SRBM may serve to course-filter VF access to physical functions, such as the memory controller, to block (where appropriate) VM access to shared resources like the memory controller. This isolates one VM's activity from another VM.

For the GPU PF register base access register (BAR), all MMIO registers may be accessed. In the non-virtualized environment, only the PF may be enabled, but in a virtualized environment mode, the PF's MMIO register BAR would be exclusively accessed by the host VM's GPU driver. Similarly, for PCI configuration space, in non-virtualized environment, the registers would be set by the OS, but in virtual mode, the hypervisor controls access to this space, potentially emulating registers back to the VMs.

Within the GPU VF register BAR, a subset of MMIO registers may be accessed. For example, VF may not expose PHY registers such as display timing controls, PCIE, DDR memory, and access to the remaining subset are exclusively accessed by the guest VM driver. For PCI configuration space, the virtual register BARs are exposed and set by the VM OS.

In another embodiment, the interrupts may need to be considered in the virtual model as well, and these would be handled by the interrupt handler (IH) IP block, which collects interrupt requests, from its clients like the graphics controller, the multimedia blocks, the display controller, etc. When collected from a client which is running under a particular VF or PF, the IH block signals to software that an interrupt is available from the given VF or PF. The IH is designed to allow its multiple clients to request interrupts from different VFs or PF with an internal interface to tag the interrupt request with the index of VF or PF. As described, in VM mode, the IH dispatches the interrupts to the system fabric, and tags the interrupts with a PF or VF tag based on its origin. The platform (hypervisor or IOMMU) forwards the interrupt to the appropriate VM. In one embodiment, the GPU is driving a set of local display devices such as monitors. The GPU's display controller in this case is constantly running in PF. The display controller would regularly generate interrupts such as vertical synchronization signals to the software. Those types of interrupts such as the display interrupts from the PF would be generated simultaneously with interrupts from another VF where graphics functionality causes generation of other types of interrupts.

In another embodiment, the hypervisor may implement a proactive paging system in an instance where the number of VMs is greater than the number of VFs. In this case, the hypervisor may (1) switch an incumbent VM out of its VF using the global context switch-out sequence after its time slice; (2) evict the incumbent VM's memory after the VF's global switch sequence is complete, (3) disconnect the incumbent VM from its VF, page an incoming VM's memory from system memory before its time slice, connect the incoming VM to the vacated VF, and run the new VM on the vacated VF. This allows more VMs to run on fewer VFs—by sharing VMs per VF.

Within the software, the hypervisor may have no hardware-specific driver. In such an embodiment, the hypervisor may have exclusive access to PCI configuration registers via a PF, which minimizes hardware specific code in the hypervisor. The hypervisor's responsibilities may include: GPU initialization, physical resource allocation, enabling virtual functions and assigning same to VMs, context save area allocation, scheduling global context switch and CPU synchronization, GPU timeout/reset management, and memory management/paging.

Similarly in the software, the host VM's role may have an optional hardware-specific driver and may have exclusive access to privileged and physical hardware functions via PFs such as the display controller or the DRAM interface. The host VMs responsibilities may include managing locally attached displays, desktop composition, memory paging in the case where the number of VMs is greater than the number of VFs. The host VM may also be delegated with some of the hypervisor's GPU management responsibilities. When implementing some features in the PF such as desktop composition and memory paging, the host VM may use the GPU for acceleration such as the graphics engine or the DMA engine. In this case, the PF would create one of the global contexts that coexist with the global contexts corresponding to the running VFs. In this embodiment, the PF would participate global context switching along with the VFs in a time-slicing fashion.

It should be understood that many variations are possible based on the disclosure herein. Although features and elements are described above in particular combinations, each feature or element may be used alone without the other features and elements or in various combinations with or without other features and elements

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the present invention.

The methods or flow charts provided herein may be implemented in a computer program, software, or firmware incorporated in a non-transitory computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for changing between virtual machines on a graphics processing unit (GPU) comprising:
requesting to switch from a first virtual machine (VM) with a first global context to a second VM with a second global context;
stopping taking of new commands in the first VM;
saving the first global context; and
switching out of the first VM.

2. The method of claim 1, further comprising allowing commands previously requested in the first VM to finish processing.

3. The method of claim 2, wherein the commands finish processing before saving the first global context.

4. The method of claim 1, wherein the first global context is saved to a memory location communicated from a bus interface (BIF) via a register.

5. The method of claim 1, further comprising signaling an indication of readiness to switch out of the first VM.

6. The method of claim 5, further comprising ending a switch out sequence.

7. The method of claim 1, further comprising restoring the second global context for the second VM from memory.

8. The method of claim 7, further comprising beginning to run the second VM.

9. The method of claim 8, further comprising signaling that the switch from the first VM to the second VM is complete.

10. The method of claim 1, further comprising signaling that the switch from the first VM to the second VM is complete.

11. The method of claim 1, wherein if a signal that the switch from the first VM to the second VM is complete is not received within a time limit, resetting the GPU for changing between virtual machines.

12. A GPU capable of switching between virtual machines comprising:
a hypervisor that manages resources for a first virtual machine (VM) and a second virtual machine (VM), wherein the first virtual machine and second virtual machine have a first and second global context;
a bus interface (BIF) that sends a global context switch signal indicating a request to switch from the first VM to the second VM; and
IP blocks that receive the global context switch and stop taking further commands in response to the request and save the first global context to memory, wherein the IP blocks send a signal to the BIF a readiness to switch out of the VM signal;
wherein on receipt of the readiness to switch out of the VM signal from the BIF, the hypervisor switches out of the first VM.

13. The GPU of claim 12, wherein the IP blocks permit commands previously requested in the first VM to finish processing.

14. The GPU of claim 13, wherein the commands finish processing before saving the first global context.

15. The GPU of claim 12, wherein the first global context is saved to a memory location communicated from the BIF via a register.

16. The GPU of claim 12, wherein the hypervisor ends a switch out sequence.

17. The GPU of claim 12, wherein the IP blocks restore the second global context for the second VM from memory.

18. The GPU of claim 17, wherein the GPU begins to run the second VM.

19. The GPU of claim 18, wherein the IP blocks signal that the switch from the first VM to the second VM is complete.

20. The GPU of claim 12, wherein if a signal that the switch from the first VM to the second VM is complete is not received within a time limit, the GPU resets for changing between virtual machines.
